(19) United States
(12) Patent Application Publication
(10) Pub. No.: US 2009/0164512 A1
(43) Pub. Date: Jun. 25, 2009

(54) Method and Computer Program Product for Managing Media Items

(76) Inventors: Netta Aizenbud-Reshef, Haifa (IL); Ella Barkan, Haifa (IL); Eran Belinsky, Haifa (IL); Michal Jacovi, Rakefet (IL); Vladimir Soroka, Karmiel (IL)

Correspondence Address: IBM CORPORATION, T.J. WATSON RESEARCH CENTER, P.O. BOX 218, YORKTOWN HEIGHTS, NY, 10598, US

(21) Appl. No.: 11/959,481

(22) Filed: Dec. 19, 2007

(51) Int. Cl. G06F 17/30

(52) U.S. Cl. 707/104.1; 707/E17.046

(57) ABSTRACT

A method and computer program product for managing media items, the method includes: clustering media items to media item groups and assigning a semantic event descriptor to each media item group in response to capture time of multiple media items, capture locations of multiple media items, event scheduling information and information extracted from media items; wherein the assigning of the semantic event descriptor is responsive to a type of the event.

### FIELD OF THE INVENTION

The present invention relates to methods and computer program products for managing media items.

### BACKGROUND OF THE INVENTION

Multiple user devices can capture media items of various types. Pictures (images), video streams, audio-visual streams, audio streams and text can be captured by a single user. A user can also receive media items of various types from peers, databases and the like.

Various media item managing tools organize media items according to their types. For example, images are stored separately from audio streams and text.

Due to the growing amount of information that is provided to users there is a growing need to provide means for organizing media items in a user friendly manner that will enable to associate together media items of the same type as well as media items of different types.

### SUMMARY

A method and computer program product for managing media items, the method includes: clustering media items to media item groups and assigning a semantic event descriptor to each media item group in response to capture time of multiple media items, capture locations of multiple media items, event scheduling information and information extracted from media items; wherein the assigning of the semantic event descriptor is responsive to a type of the event.

### BRIEF DESCRIPTION OF THE DRAWINGS

The present invention will be understood and appreciated more fully from the following detailed description taken in conjunction with the drawings in which:

FIG. 1 illustrates two time location windows according to an embodiment of the invention;

FIG. 2 illustrates a system for managing media items and its environment according to an embodiment of the invention;

FIG. 3 is a flow chart of a method for managing media items, according to an embodiment of the invention; and

FIG. 4 illustrates a stage of the method of FIG. 3, according to an embodiment of the invention.

### DETAILED DESCRIPTION OF THE DRAWINGS

A method for managing media items is provided. The method locates media item groups that are associated with different events. A media item group associated with a certain event can be described by a semantic event descriptor. The semantic event descriptor can be used for indexing and retrieval of media items.

According to an embodiment of the invention a two-phased process is provided. During a first phase media items are partitioned to media item sets. Each media item set is associated with a time location window. A semantic set descriptor is assigned to each media item set. The semantic set descriptor can be used for indexing and retrieval of media items. During a second phase media item sets are partitioned to media item groups. Each media item set can include one or more media item groups.

One or more events can occur during a time location window (hereinafter—window). The boundaries (time period, distance between locations of captured media items, timing gap between capture time of media items and the like) can be defined in various manners. For example, media items can be sorted according to their capture time and a window can be delimited by consecutive media items that have a large timing gap between them. Yet for another example, the maximal duration and/or space that is “covered” by a single window can be set in advance. Different windows can have different sizes. A window can be limited to a certain location but this is not necessarily so. A single window can include events of multiple types, as explained below.

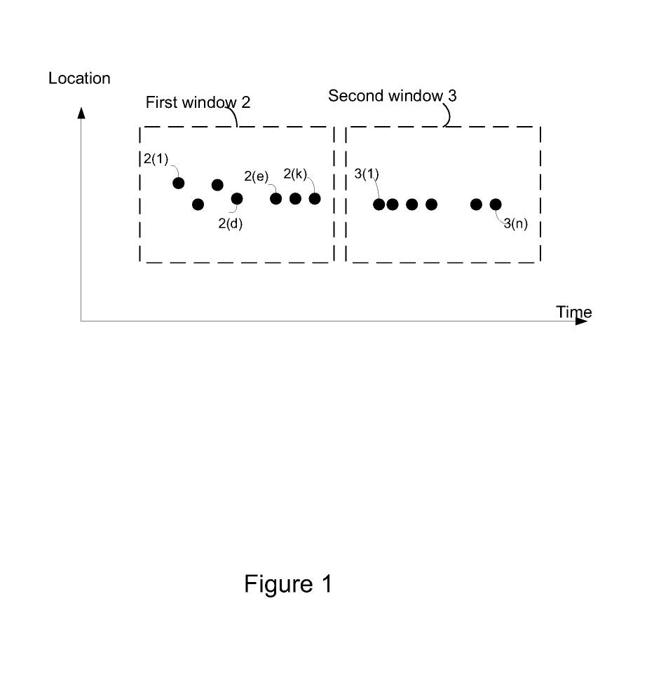

FIG. 1 illustrates two windows 2 and 3 in a time space coordinate system. First window 2 includes a first media item set that includes media items 2(1)-2(k) while second window 3 includes a second media item set that includes media items 3(1)-3(n). The sizes of the first and second windows may differ from each other. Each of first and second media item sets can include one or more media item groups. For example, media items 2(1)-2(d) belong to a certain media item group while media items 2(e)-2(k) belong to another media item group.

Media items can be displayed, stored and indexed according to the semantic descriptors assigned to the corresponding sets and groups.

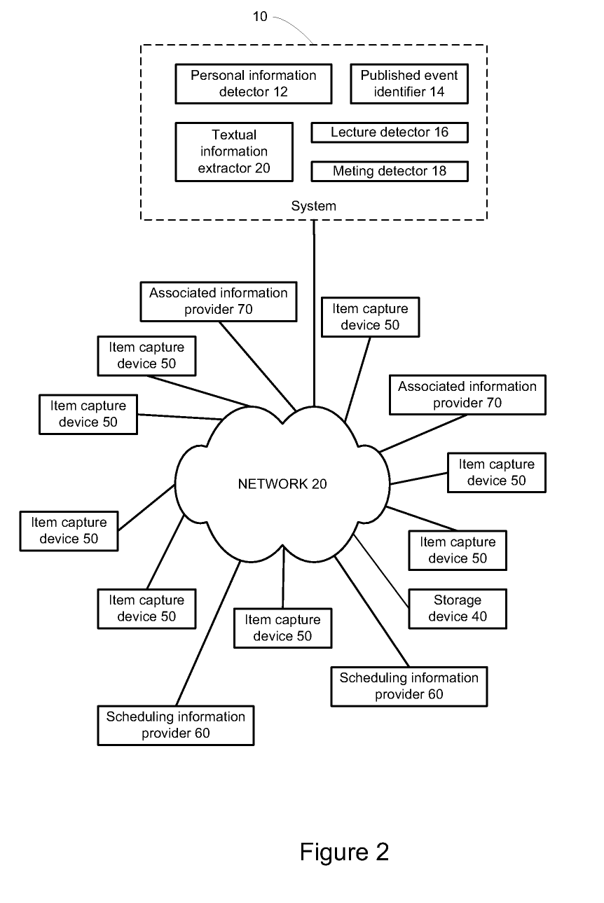

FIG. 2 illustrates system 10 for managing media items and its environment according to an embodiment of the invention.

System 10 includes: (i) personal information detector 12 that is adapted to detect personal information included within at least one media item; (ii) published event identifier 14 that is adapted to detect information relating to a published event, the information being captured in at least one media item; (iii) lecture detector 16 that is adapted to detect a lecture during which one or more media items were captured; (iv) meeting detector 18 that is adapted to detect a meeting with one or more persons during which one or more media items were captured; (iv) information extractor 20 that can include at least one image processor and, additionally or alternatively, at least one audio processor, wherein information extractor 20 can process a media item to extract information from the media item. It is noted that information extractor 20 can provide information to other detectors (such as published event identifier 14, lecture detector and the like). Alternatively, some detectors may have information extraction capabilities. It is further noted that information extractor 20 can, for example, extract textual information, auditory information, visual information or a combination thereof.

System 10 is connected to network 20. Network 20 is connected to storage device 40, to multiple media item capture devices 50, to scheduling information providers 60 and to associated information providers 70.

A media item capture device can be a camera, a mobile phone equipped with a camera; a personal digital accessory equipped with a camera and the like. A media item capture device can, additionally or alternatively, have audio recording capabilities.

Scheduling information providers 60 provide scheduling information about timing and/or content of events in which a person that is expected to capture the media items is expected to participate. These providers can include collaboration tools but this is not necessarily so. Sample scheduling information can be included in electrical calendars, web-site stating the user as participating in a session at a given time & location, or a time-log of user locations.

Network 20 can also be connected to associated information providers 70 that provide information relating to the timing of media item capture and, additionally or alternatively, to the location of a media item capture. Associated information providers 70 can include, for example, a base station of a cellular network that can determine the location of a mobile phone. It is noted that associated information can be provided by the item capture device 50 and even from metadata associated with the media item.

It is noted that although associated information providers 70, media item capture devices 50 and scheduling information providers 60 are illustrated as different entities this is not necessarily so.

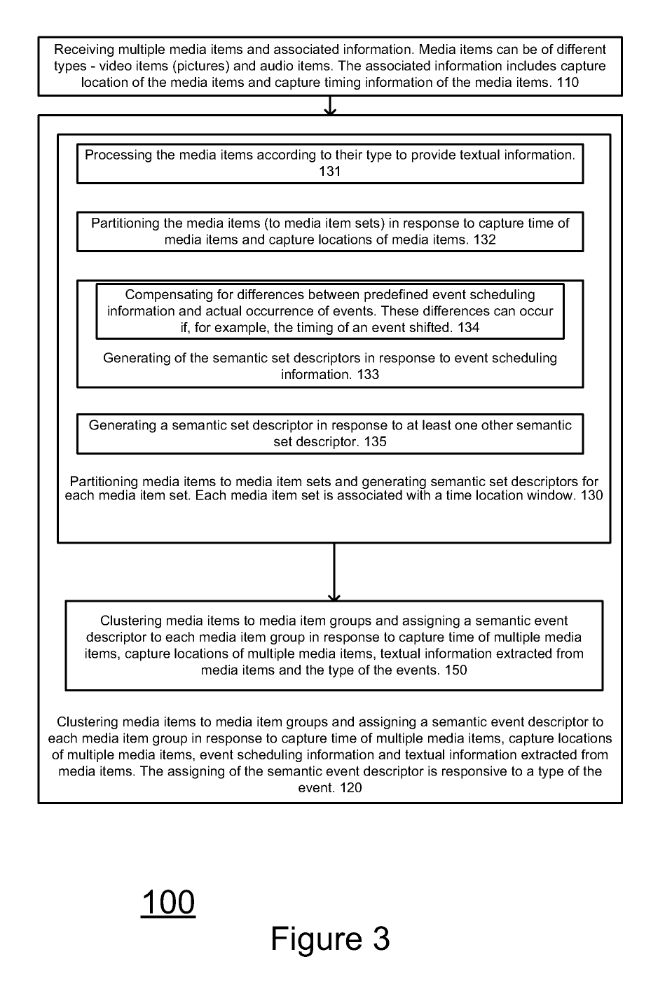

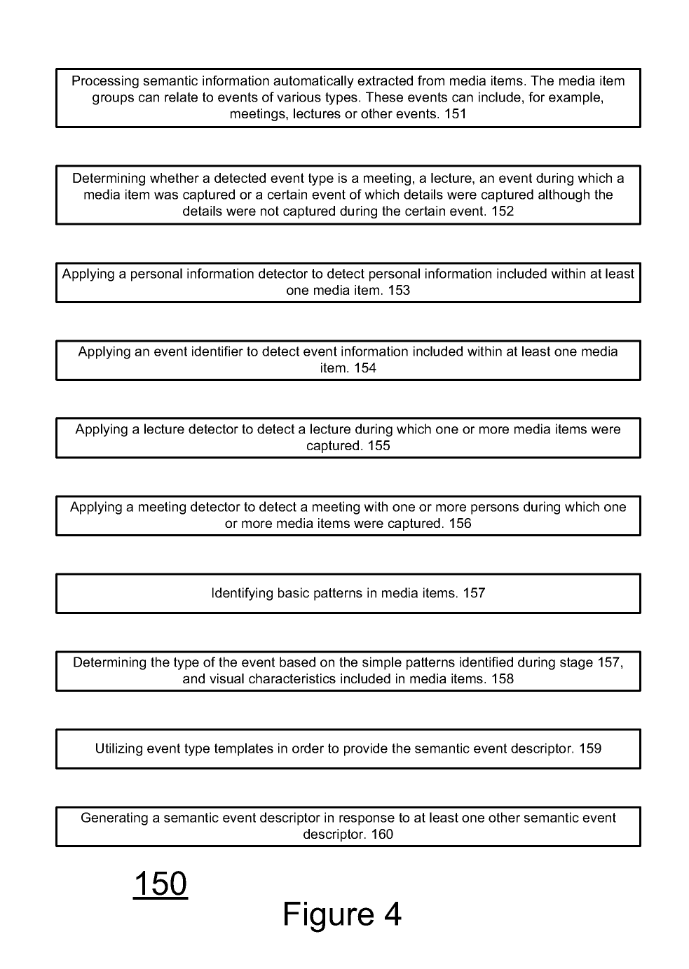

System 10 can execute method 100 of FIGS. 3 and 4.

FIG. 3 illustrates method 100 according to an embodiment of the invention and FIG. 4 illustrates stage 150 of method 100 according to an embodiment of the invention. It is noted that for simplicity of explanation FIG. 3 illustrates a sequence of stages, although it is noted that the stages are not necessarily executed in that order and that some stages can be executed in parallel to each other. For example, the detecting of events and clustering can occur at least partially in parallel.

Method 100 starts by stage 110 of receiving multiple media items and associated information. Media items can be of different types—visual items (such as pictures) and audio items. The associated information includes capture location of the media items and capture timing information of the media items.

Capture location can be provided by the device that captured a media item (for example Global Positioning Systems (GPS) based devices) or by other devices or components that communicate with the device. For example, wireless networks can use triangulation or other location algorithms to detect the location of a mobile device that captures media items. Yet for another example, the location of devices that utilize short range transmission can be detected based upon interfaces between these long range transmissions and short range transmissions.

Stage 110 is followed by stage 120 of clustering media items to media item groups and assigning a semantic event descriptor to each media item group in response to capture time of multiple media items, capture locations of multiple media items, event scheduling information and information extracted from media items. The assigning of the semantic event descriptor is responsive to a type of the event.

Conveniently, stage 120 includes stage 130 and 150. Stages 130 and 150 form the mentioned above two phase process. It is noted that stage 150 can be conveniently executed without the initial partition of media items to media sets.

Stage 130 includes partitioning media items to media item sets and generating semantic set descriptors for each media item set. Each media item set is associated with a time location window.

Stage 130 includes at least one stage out of stages 131, 132 and 133 or a combination thereof. It is noted that the stages are not sorted according to their chronological order.

Stage 131 includes processing the media items according to their type to provide information. Pictures can be processed by image processors that extract information from these pictures. The extraction can involve applying Optical Character Recognition techniques. Textual information can include letters, number, symbols, and graphical information. Audio frames can be processed by voice recognition modules to extract information. The extracted information can be used for providing semantic set descriptors.

Stage 132 includes partitioning the media items (to media item sets) in response to capture time of media items and capture locations of media items. The partitioning includes determining the media items that belong to each window.

Stage 133 includes generating of the semantic set descriptors in response to event scheduling information.

The event scheduling information can be retrieved from computerized calendars, but this is not necessarily so. The scheduling information can include timing information as well as contextual information. The event scheduling information can be processed in order to provide semantic set descriptors that have a semantic meaning. These descriptors should be meaningful to a user, in order to simplify the retrieval of media items.

A window can be represented by one or more calendar entries. The semantic set descriptor can be taken from that calendar entry. If, for example, there is a single calendar entry at a time that corresponds to the window then the semantic set descriptor is taken from the name (or other contextual information) associated with that calendar entry. If, for example, there are several non-overlapping calendar entries in a timeframe that corresponds to the window then the media item set can be partitioned to multiple media item sets, each having its semantic set descriptor. If there are conflicting calendar entries for a given time period associated with a single window, one of several heuristics can be applied to provide the semantic set descriptor. For example, concatenating the conflicting calendar entry titles, using capture derived information, and the like. It is noted that the sets of these conflicting entries can be merged. It is further noted that these conflicting calendar entries can be broken into multiple sets (only first entry, conflicting time, only second entry). It is further noted that textual or contextual information from the captures may indicate which of the calendar entries really took place. Yet for another example, if there are windows that do not have a related calendar entry then the assignment of semantic set descriptor can be postponed to another stage. Additionally or alternatively, the assignment of a semantic set descriptor can include a reference to another window (another media item group) that already has a semantic set descriptor (for example if a certain window was assigned with a semantic set descriptor X then nearby windows can be assigned with the following semantic set descriptors—“before X”, “after X”, and the like).

Stage 133 can include stage 134 of compensating for differences between predefined event scheduling information and actual occurrence of events. These differences can occur if, for example, the timing of an event shifted. The compensation can be based upon correlating between the content of media items captured during an event and the time of capture and the predefined timing of the event. It is noted that the compensation can, additionally or alternatively, based upon other information such as location information (included in the scheduling information) and location information extracted from media items. The same can be applied mutatis mutandis to persons that should have been met (included in the scheduling information) and personal details extracted from the media items.

Stage 135 includes generating a semantic set descriptor in response to at least one other semantic set descriptor. This can occur, for example, if other media item sets (for example previous or next media item sets) already have a semantic set descriptor but stage 130 is not able to generate a meaningful semantic set descriptor to the certain media item groups.

Stage 150 includes clustering media items to media item groups and assigning a semantic event descriptor to each media item group in response to capture time of multiple media items, capture locations of multiple media items, information extracted from media items and the type of the events. Conveniently, the semantic event descriptors are assigned in response to information extracted from media items, type of the events and optionally to the location of the event, and additionally or alternatively to the timing of the event.

It is noted that the information from media items can be processed in order to determine the type of the event. It is further noted that the type of the event can also be learnt from event scheduling information. A calendar entry can indicate, for example, that a person (that captures media items) is participating in a meeting, attends a lecture, and the like.

Stage 150 includes at least one stage out of stages 151-160 or a combination thereof.

Stage 151 includes processing semantic information automatically extracted from media items. The media item groups can relate to events of various types. These events can include, for example, meetings, lectures or other events.

Stage 152 includes determining whether a detected event type is a meeting, a lecture an event during which a media item was captured or a certain event of which details were captured although the details were not captured during the certain event. Such a certain event can be an event that is published on a poster whereas pictures of the poster are taken during another event (a meeting, a lecture, and the like).

Stage 157 includes identifying basic patterns in media items that are mainly based on the text, such as place names, person names, email addresses, URLs, phone numbers, dates, etc.

Stage 157 is conveniently followed by stage 158 of determining the type of the event based on the simple patterns identified during stage 157 and in view of visual characteristics included in media items. It is noted that a single media item can include information relating to multiple events. In this case it can belong to multiple media item groups. For example, a certain image can include a poster and an image of a person. The poster indicates that a certain event is scheduled to occur (or has occurred). The image of the person was captured during a meeting with that person (which is an event that differs from the certain event).

The semantic event descriptor can reflect various information items relating to the event. Such items can include event type (conference, summit, competition, symposium and the like), event date, event location and the like. Text can be extracted and processed by well known text extraction and processing method. For example, certain information items (date, location, event title, event data) are typically used to describe a published event. The processing of a publication can include searching for these items. The meaning of the extracted text (especially the title of the event) can be located based upon the location of text, font, size, and the like.

Stage 153 includes applying a personal information detector to detect personal information included within at least one media item. Personal information can be detected by identifying basic patterns that are attributed to person information, such as: Person Name, Company Name, Phone numbers of various types (office, fax, mobile), email, etc. Stage 153 can include combining spatial information and typographical characteristics of textual information that is extracted from media items, such as the division of an image into different blocks of text, taking into account the size of words, bold/italics characteristics, capitalization, text color, etc. For example, a person's name in business cards is either located in the first line of the text block or emphasized by using a different font type, boldness or size

Stage 154 includes applying a published event identifier to detect event information included within at least one media item.

Stage 155 includes applying a lecture detector to detect a lecture during which one or more media items were captured. Conveniently, stage 155 includes applying a pattern based clustering process. If, for example, several consecutive captured media items are identified as “Slides” they can be grouped together to a “Lecture”. Identification of the “Slides” pattern is done by detecting similarity of consecutive images and features that are unique to slide images. Similarity of the consecutive images can be done by comparison between feature vectors that include information about image data, layout and font information. Unique slide features include: a starting slide (including a title and author information), an ending slide (containing words such as ‘Thank You’, “Questions’, etc.) and unique slides layout, such as: bulleted/numbered list, header, footer, horizontal lines. Each such feature raises the probability for a Slide type. It is noted that not all features must be present in order to mark a series of captures as “slides” belonging to a “lecture”. If the same object appears in a series of slides, or some other image-similarity is identified (for example—the same template appears in multiple “slides”), it is likely that this is the same lecture, even if the time difference between pictures is longer than a predefined time gap allowed between consecutive media items.

Stage 156 includes applying a meeting detector to detect a meeting with one or more persons during which one or more media items were captured. A meeting can be detected if, for example, consecutive media items include images of the same person as well as personal information.

Stage 159 includes utilizing event type templates in order to provide the semantic event descriptor. If, for example, personal Information is located in a media item then that event can be provided with the semantic event descriptor of “Meeting with <person name>”. If an event is published (thus the event type is an event publication) then the published event can be associated with the semantic event descriptor of: “<Future|Past> Event: <title>” will be added to the title. If the event is a lecture then the lecture can be associated with the semantic event descriptor of “Lecture <title> By <person name>”. The lecturer name can be found, for example, by processing the first or last slide.

Stage 160 includes generating a semantic event descriptor in response to at least one other semantic event descriptor. This can occur, for example, if other media item groups already have a semantic event descriptor but stage 150 is not able to generate a meaningful semantic event descriptor to a certain media item group.

It is further noted that a semantic set descriptor can be responsive to one or more semantic event descriptors.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for managing media items, the method comprises:
clustering media items to media item groups; and
assigning a semantic event descriptor to each media item group in response to capture time of multiple media items, capture locations of multiple media items, event scheduling information and information extracted from media items; wherein the assigning of the semantic event descriptor is responsive to a type of the event.

2. The method according to claim 1 wherein the clustering comprises: partitioning media items to media item sets; wherein each media item set is associated with a time location window; and generating a semantic set descriptor.

3. The method according to claim 2 wherein the partitioning is responsive to capture time of media items, capture locations of media items; and wherein the generating of the semantic set descriptor is responsive to event scheduling information.

4. The method according to claim 2 comprising compensating for differences between predefined event scheduling information and actual occurrence of events.

5. The method according to claim 2 comprising generating a semantic set descriptor in response to at least one other semantic set descriptor.

6. The method according to claim 1 comprising associating a semantic event descriptor template with an event in response to a type of the event.

7. The method according to claim 1 comprising determining whether an event type is a lecture, an event during which a media item was captured or a certain event of which details were captured although the details were not captured during the certain event.

8. The method according to claim 1 comprising applying a personal information detector to detect personal information included within at least one media item.

9. The method according to claim 1 comprising applying a published event identifier to detect event information included within a publication captured in at least one media item.

10. The method according to claim 1 comprising applying a lecture detector.

11. A computer program product comprising a computer usable medium including a computer readable program, wherein the computer readable program when executed on a computer causes the computer to: cluster media items to media item groups and assign a semantic event descriptor to each media item group in response to capture time of multiple media items, capture locations of multiple media items, event scheduling information and information extracted from media items; wherein the assignment of the semantic event descriptor is responsive to a type of the event.

12. The computer program product according to claim 11 that causes the computer to partition media items to media item sets; wherein each media item set is associated with a time location window; and generating a semantic set descriptor.

13. The computer program product according to claim 12 that causes the computer to partition media items to media item sets in response to capture time of media items and capture locations of media items; and to generate the semantic set descriptor in response to event scheduling information.

14. The computer program product according to claim 12 that causes the computer to compensate for differences between predefined event scheduling information and actual occurrence of events.

15. The computer program product according to claim 12 that causes the computer to generate a semantic set descriptor in response to at least one other semantic set descriptor.

16. The computer program product according to claim 11 that causes the computer to associate a semantic event descriptor template with an event in response to a type of the event.

17. The computer program product according to claim 11 that causes the computer to determine whether an event type is a lecture, an event during which a media item was captured or a certain event of which details were captured although the details were not captured during the certain event.

18. The computer program product according to claim 11 that causes the computer to apply a personal information detector to detect personal information included within at least one media item.

19. The computer program product according to claim 11 that causes the computer to apply a published event identifier to detect event information included within a publication captured in at least one media item.

20. The computer program product according to claim 11 that causes the computer to apply a lecture detector.
